(19) United States
(12) Patent Application Publication
(10) Pub. No.: US 2021/0214946 A1
(43) Pub. Date: Jul. 15, 2021

(54) ROLLED SELF-ADHERING ROOFING AND METHODS OF MANUFACTURE THEREOF

(71) Applicant: John SELBACH, Lighthouse Point, FL (US)

(72) Inventor: John SELBACH, Lighthouse Point, FL (US)

(21) Appl. No.: 16/739,108

(22) Filed: Jan. 9, 2020

(51) Int. Cl. E04D 5/14; B32B 7/12; E04D 5/12

(52) U.S. Cl. CPC E04D 5/148; B32B 7/12; E04D 2001/005; B32B 2419/06; E04D 5/12

(57) ABSTRACT

An apparatus useful for roofing includes a flexible planar material comprising a back surface on a first side, and an outer surface on a second side opposite the first side; and a granule layer disposed on the outer surface, the granule layer comprising a shingle design formed by a first plurality of granules and a second plurality of granules of the granule layer.

### FIELD

The disclosure relates to roofing materials and roofing. In particular, the disclosure relates to rolled, self-adhering roofing materials having an architectural cap surface.

### BACKGROUND

Conventional roofing systems may include a base roof layer. The base may be nailable roof ply or other material, or may include coverboard or insulation. Fasteners, and adhesive or primer may be disposed on the base. In some roofing systems a sheet overlaying the base roof layer. Many residential roofing systems and some commercial roofing systems include a surface layer or cap layer formed of shingles, whether cedar, asphalt, or other material. Shingles with asphalt surfaces and tar-adhesive backing are nailed into or otherwise adhered to a base roof layer such as play, typically over an intervening sheet or membrane.

Related art commercial roofing systems include rolled roofing or self-adhering roofing layers. Such products are well known and commercially available. Some commercially available products include a square, polyester reinforced cap sheet that are configured for installation on nailable or non-nailable substrates. The cap sheets may include a surface having granules configured and arranged for UV protection and ornamentation and appearance. These related art cap sheets do not overlay one another after installation to form a shingled effect suitable for residential application and consumer demand for a shingled architectural appearance for roofing.

Roof materials may be adhered to a roof base layer by mechanical fasteners, hot asphalt, cold adhesive, torch, or self-adhesive. Mechanical fasteners are suitable for base sheets underlying other protective layers. Hot asphalt is durable but requires trained personnel, specialized equipment, and carries risk of fire and noxious fumes. Cold adhesives minimize fire risks, but can take several months to cure. Torch application of a roofing layer carries risks and also requires specialized equipment and trained personnel. Self-adhering systems are known for their ease in installation, acceptable adhesion, and elimination of fire or fume risks.

### SUMMARY

A need has been recognized for a roof layer product having an architectural shingle appearance of any now known or later developed ornamental design, and having a profile and flexibility suitable for rolling for storage transport, and easy installation. The roofing apparatus and methods disclosed herein meet these needs.

A roof apparatus in accordance with embodiments is configured in accordance with now known or later developed methods to be suitable for residential or commercial roofing requirements. A roof apparatus is a layer of flexible roofing material selected from any suitable now known or later developed material with a back surface that faces a roof installed, and an outer surface that faces away from a roof installed. The outer surface includes a granule layer for UV protection and appeal. The back surface includes a portion having adhesive disposed thereon that, upon installation to a roof surface, adheres the roof apparatus to the roof with sufficient strength and seal. The adhesive portion may be in the form of a strip, multiple strips, or any other shape or pattern that is functional and cost-effective to produce. The adhesive may be selected for suitability from any now known or later developed material. A joint strip may be disposed on the outer surface. The joint strip may include adhesive suitable for adhering to and joining an adjacent, overlapping roof apparatus. The outer surface includes a granule layer having a granule color pattern, a granule pile height differential, or a combination thereof that provides the appearance of a architectural shingles or desirable dimension and layered appearance in residential applications and some commercial application.

A roof apparatus in accordance with an example embodiment includes a flexible planar material comprising a back surface on a first side, and an outer surface on a second side opposite the first side; and a granule layer disposed on the outer surface, the granule layer comprising a shingle design formed by a first plurality of granules and a second plurality of granules of the granule layer. One embodiment includes a joint strip disposed on the outer layer. The joint strip may include an adhesive. One embodiment includes the back surface having adhesive.

In an embodiment, the the flexible planar material and the granule layer together have flexibility suitable for rolling into a rolled configuration. In an embodiment, the first plurality of granules comprising a first color and the second plurality of granules comprising a second color, together forming a shingle pattern. In an embodiment, the first plurality of granules comprising a first pile height and the second plurality of granules comprising a second pile height, together forming a shingle pattern.

A method useful for forming a roof apparatus in accordance with an example embodiment includes providing a flexible planar material comprising a back surface on a first side, and an outer surface on a second side opposite the first side; and a granule layer disposed on the outer surface, the granule layer comprising a shingle design formed by a first plurality of granules and a second plurality of granules of the granule layer.

In an embodiment, methods include providing a granule layer wherein the first plurality of granules comprising a first color and the second plurality of granules comprising a second color, together forming a shingle pattern. The granules may be pre-colored before application. Alternatively, or additionally, the granule may colored after application by, for example, painting the granule layer disposed on the outer surface. In another embodiment, methods include providing a granule layer wherein the first plurality of granules comprising a first pile height and the second plurality of granules comprising a second pile height, together forming a shingle pattern.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a perspective view of a related art roof apparatus;

FIG. 2 shows perspective view of a roof apparatus in accordance with an embodiment;

FIG. 3 shows a perspective view of a roof apparatus partially rolled in accordance with an embodiment;

FIG. 4 shows a perspective view of a roof apparatus in accordance with another embodiment;

FIG. 5 shows a perspective top view of a roof on which a roof apparatus and system is installed;

FIG. 6 shows a flow diagram of methods in accordance with embodiments.

### DETAILED DESCRIPTION OF EMBODIMENTS

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

Embodiments of roof apparatus, systems and methods are disclosed that provide a roof layer product having an architectural shingle appearance of any now known or later developed ornamental design, and having a profile and flexibility suitable for rolling for storage transport, and easy installation.

A roof apparatus in accordance with embodiments is configured in accordance with now known or later developed methods to be suitable for residential or commercial roofing requirements. A roof apparatus is a layer of flexible roofing material selected from any suitable now known or later developed material with a back surface that faces a roof installed, and an outer surface that faces away from a roof installed. The outer surface includes a granule layer for UV protection and appeal. The back surface includes a portion having adhesive disposed thereon that, upon installation to a roof surface, adheres the roof apparatus to the roof with sufficient strength and seal. The adhesive portion may be in the form of a strip, multiple strips, or any other shape or pattern that is functional and cost-effective to produce. The adhesive may be selected for suitability from any now known or later developed material.

In an embodiment, a joint strip may be disposed on the outer surface. The joint strip may include adhesive suitable for adhering to and joining an adjacent, overlapping roof apparatus. The outer surface includes granule layer having a granule color pattern, a granule pile height differential, or a combination thereof that provides the appearance of a architectural shingles or desirable dimension and layered appearance in residential applications and some commercial application. In other embodiments, no joint strip may be included and no means for joining adjacent, overlapping roof apparatus. In other embodiments, alternative devices and methods, now known or later developed, suitable for joining adjacent, overlapping roof apparatus.

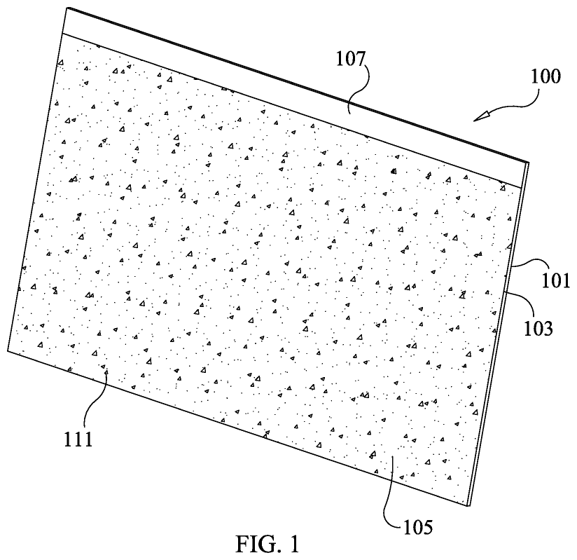

A related art roofing apparatus is shown in FIG. 1. In particular, FIG. 1 shows a perspective view of a shingle 100 including a bottom surface 101 (edge only shown), a side surface 103, and a top or outer surface 105. A joint strip 107 is disposed on the outer surface 105. The joint strip 107 includes an adhesive that joins adjacent and overlapping roof apparatus. The outer surface may include a granule layer 111 as shown in FIG. 1. The granule layer 111 includes a substantially uniform color, granule distribution pattern, and overall appearance.

The shingle 100 may be arranged in a shingled configuration on a sloped roof. For example, the shingle 100 may be sized for use as a shingle. The back 101 of the shingle 100 may include an adhesive strip, and the roofing apparatus may be installed on a roof in an overlapping fashion with numerous other shingles. Each of the shingles is nailed into the roof, each being separately fitted and secured.

Other related roofing material is known to reduce materials, costs, and installation time. In particular, rolled roofing materials are known and include a rolled or spooled strip of adhesive-backed roofing material. Some rolled roofing products known in the related art include an outer granule layer for protection and aesthetics. Such products are not, however, useful for arrangement in a shingled configuration and are conventionally used in commercial roofing applications requiring covering for substantially flat, not angled, roofs.

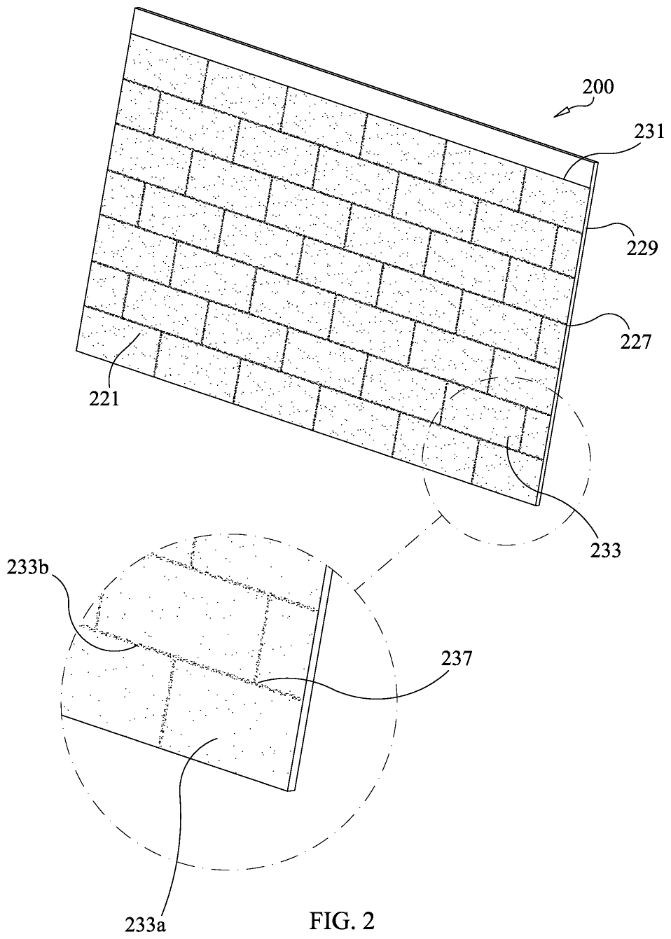

FIG. 2 shows a perspective view of a roofing apparatus in accordance with an embodiment of this disclosure. FIG. 2 shows a perspective view of a roofing apparatus 200 including a top or outer surface 221, a side surface 227, and a bottom surface 229 (edge only shown). A joint strip 231 is disposed on the outer surface 221. In other embodiments, no joint strip, or an alternative joining system is used. The joint strip 231 included in the embodiment shown in FIG. 1 includes an adhesive that joins adjacent and overlapping roof apparatus.

The outer surface 221 includes a granule layer 233 as shown in FIG. 2. The granule layer 233 including a first plurality of granules 233a and a second plurality of granules 233b. The first plurality of granules 233a and the second plurality of granules 233b form a shingle pattern 237. The shingle pattern 237 may be configured as shown, or may be any other variation of pattern formed of the first plurality of granules 233a and the second plurality of granules 233b. The pattern may be formed by using different color granules, using granules of different sizes, arranging granules in different pile heights, or any combination of the foregoing to provide a shingle pattern appearance.

By way of the example, the roofing apparatus 200 includes a shingle pattern 237 formed by using different color granules. In particular, the first plurality of granules 233a is a first color, and the second plurality of granules 233b is a second color, darker than the first color. The combined effect of the color difference and granule configuration is shingle appearance, or the appearance of a shingle effect and thus an easily stored, transported, and installed roofing system without the drawbacks of a shingled roof system.

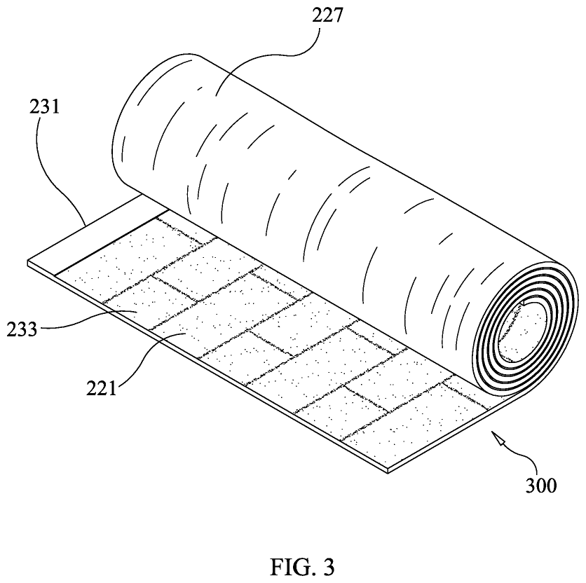

FIG. 3 shows a perspective view of a rolled roofing apparatus in accordance with an embodiment. The roofing apparatus 200 shown in FIG. 2 may larger than the section shown. The roofing apparatus 300 may be a portion of a roofing apparatus cut from a larger portion that can be arranged on a spool or in a rolled configuration. The roofing apparatus 300 may be formed of any now known or later developed material suitable for roof covering application and having flexibility for rolling. Thus, a rolled roofing material is provided that includes a shingled appearance useful visible roofing applications.

FIG. 3 shows an outer side 221 revealed as the roofing apparatus 300 is unrolled from a rolled configuration wherein only a back 227 of the roofing apparatus 300 is plainly visible on an outer side of the roll. A joint strip 231 may be included, covered or uncovered, and configured for rolling and for use after unrolling the roofing apparatus 300 for installation. The roll 300 includes a shingle layer 233 disposed on the outer side 221. The shingle layer 233 forms a shingled appearance. The back 227 may include an adhesive for adhering the roofing apparatus 300 to a surface for installation. Thus, a roofing apparatus is provided the provides a shingled roof appearance using minimal materials, storage, transportation costs, and tools and parts such as nails and other fasteners typically required for installation.

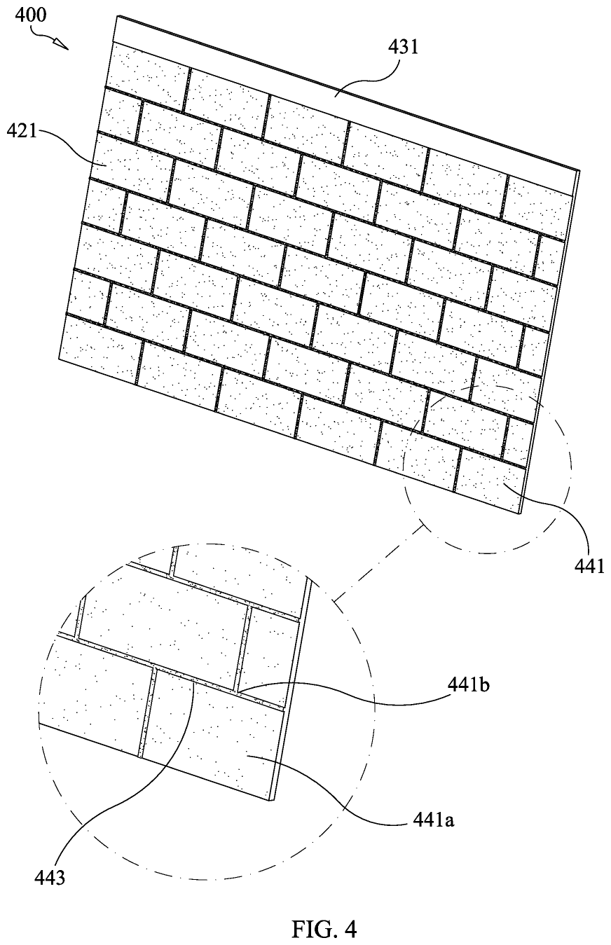

FIG. 4 shows a perspective view of a roofing apparatus in accordance with another embodiment of this disclosure. FIG. 4 shows a perspective view of a roofing apparatus 400 including a top or outer surface 421, a side surface 427, a bottom surface 429 (edge only shown), and a top or outer surface 441. A joint strip 431 is disposed on the outer surface 441. The joint strip 431 includes an adhesive that joins adjacent and overlapping roof apparatus.

The outer surface 441 includes a granule layer 441 as shown in FIG. 4. The granule layer 441 includes a first plurality of granules 441a and a second plurality of granules 411b. The first plurality of granules 441a and the second plurality of granules 441b form a shingle pattern 443. The shingle pattern 443 may be configured as shown, or may be any other variation of pattern formed of the first plurality of granules 441a and the second plurality of granules 441b. The pattern may be formed by using different color granules, using granules of different sizes, arranging granules in different pile heights, or any combination of the foregoing to provide a shingle pattern appearance.

By way of the example, the roofing apparatus 400 includes a shingle pattern 443 formed by using different color granules. In particular, the first plurality of granules 441a is a first color, and the second plurality of granules 441b is a second color, darker than the first color. The combined effect of the color difference and granule configuration is shingle appearance, or the appearance of a shingle effect and thus an easily stored, transported, and installed roofing system without the drawbacks of a shingled roof system.

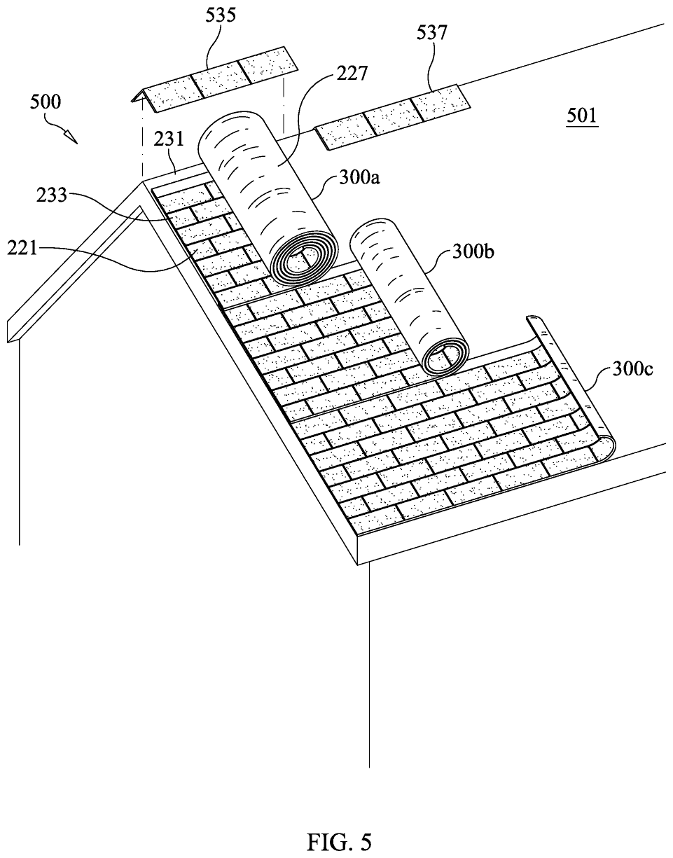

FIG. 5 shows an embodiment of roof apparatus and systems installed on a roof. In particular, FIG. 5 shows a structure and a roof system 500 disposed on a roof 501 on which a roof apparatus and system is installed. The roof 501 is a sloped roof typical of those used in residential home applications, but also used in other contexts. Roof apparatus and systems of embodiments are useful for angled roofs as shown in FIG. 5, and also flat roofs (not shown). FIG. 5 shows a perspective view of several rolled roofing apparatus 300a-b in accordance with an embodiment of a system 500. The rolled roofing apparatus 300a-b may be formed of any now known or later developed material suitable for roof covering application and having flexibility for rolling. Thus, a rolled roofing material is provided that includes a shingled appearance useful visible roofing applications.

FIG. 5 shows an outer side 221 revealed as the roofing apparatus 300a-b are unrolled from a rolled configuration wherein only a back 227 of the roofing apparatus 300a-b is plainly visible on an outer side of the roll. A joint strip 231 may be included, covered or uncovered, and configured for rolling and for use after unrolling the roofing apparatus 300 for installation. As shown in FIG. 5, the roof apparatus 300a-b are in different stages unrolling, and are layered over one another, covering respective joint strips 231. The roll 300 includes a shingle layer 233 disposed on the outer side 221. The shingle layer 233 forms a shingled appearance. The back 227 may include an adhesive for adhering the roofing apparatus 300 to a surface for installation, such as the roof 501 shown in FIG. 5. Thus, a roofing apparatus is provided the provides a shingled roof appearance using minimal materials, storage, transportation costs, and tools and parts such as nails and other fasteners typically required for installation.

FIG. 5 shows a roof cap 535 arranged for installation at a peak of the roof 501, covering the joint strip 231 of the roof apparatus 300a. The roof cap 535 is also formed of a unitary peice, like the roof apparatus described herein, and including a coloring differential and/or pile height differential of surface material configured to provide a shingle effect. FIG. 5 shows a roof cap 537 optionally installed direclty at a peak of the roof 501 without covering a joint strip 231. In some alternative embodiments of systems and methods, the rolled roof apparatus may be configured without a joint strip, and instead arranged to adjoin without overlapping. Likewise, the roof cap 537 may be disposed adjacent to, but not overlapping an installed rolled roof apparatus.

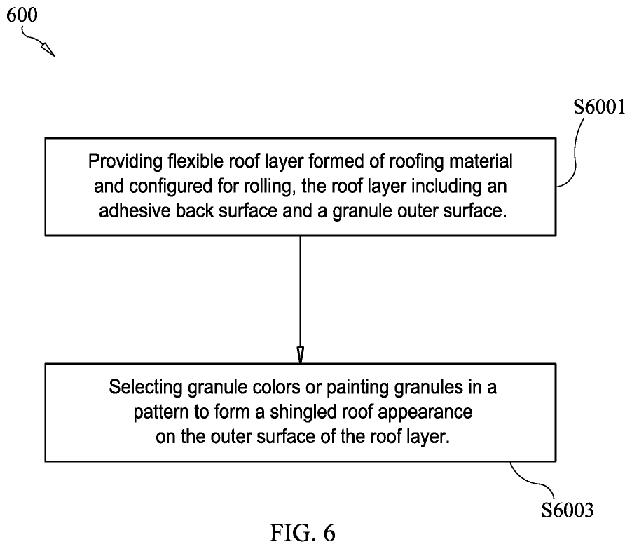

FIG. 6 shows an embodiment of methods or processes useful for manufacturing a roof apparatus configured for rolling and including an outer surface with an architectural shingle appearance formed by a granule layer. In particular, FIG. 6 shows a process 600 including a step S6001 of providing a flexible roof layer. The flexible roof layer is formed of a material suitable for roofing applications, and is configured to have a thickness and flexibility suitable for rolling or spooling. The flexible roofing material includes a back or bottom surface, and a front or top surface that constitutes an outer surface when installed on a roof.

FIG. 6 shows a step S6003 of applying a first plurality of granules to the outer surface to form a granule layer. FIG. 6 shows a step S6005 of applying a second plurality of granules to the outer surface to form the granule layer. The first plurality of granules may have a different color, size, or shape granule composition than the second plurality of granules. Alternatively, or additionally, a first color may be applied to the first plurality of granules, and a second color may be applied to the second set of granules.

The first and second colors may be applied before the granules are applied to the outer surface. Alternatively, the first and second colors may be applied after the granules are applied to the outer surface.

In another alternative embodiment, the first plurality of granules may be applied to a first pile height, and the second plurality of granules may be applied to a second pile height. A pile height of the granules is a height reached by a granule or stack of granules on the outer surface after application. The second pile height may be, for example, lower than the first pile height, and arranged in a shingle pattern. The effect of the height difference between pattern lines and granule configuration is shingle appearance, or the appearance of a shingle effect and thus an easily stored, transported, and installed roofing system without the drawbacks of a shingled roof system.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus useful for roofing, comprising:
a flexible planar material comprising a back surface on a first side, and an outer surface on a second side opposite the first side; and
a granule layer disposed on the outer surface, the granule layer comprising a shingle design formed by a first plurality of granules and a second plurality of granules of the granule layer.

2. The apparatus of claim 1, comprising:
a joint strip disposed on the outer layer.

3. The apparatus of claim 2, the joint strip further comprising:
an adhesive.

4. The apparatus of claim 3, the joint strip disposed on a side portion of the outer surface.

5. The apparatus of claim 1, the back surface further comprising:
an adhesive.

6. The apparatus of claim 1, comprising the granule layer covering an entire area of the outer surface.

7. The apparatus of claim 1, comprising the granule layer covering a majority of the area of the outer surface.

8. The apparatus of claim 1, the granule layer comprising a continous layer of one or more granules in thickness.

9. The apparatus of claim 1, the flexible planar material and the granule layer together having flexibility suitable for rolling into a rolled configuration.

10. The apparatus of claim 1, the first plurality of granules comprising a first color and the second plurality of granules comprising a second color, together forming a shingle pattern.

11. The apparatus of claim 1, the first plurality of granules comprising a first pile height and the second plurality of granules comprising a second pile height, together forming a shingle pattern.

12. A method useful for forming a roofing apparatus, comprising:
providing a flexible planar material comprising a back surface on a first side, and an outer surface on a second side opposite the first side; and
a granule layer disposed on the outer surface, the granule layer comprising a shingle design formed by a first plurality of granules and a second plurality of granules of the granule layer.

13. The method of claim 12, comprising:
providing a joint strip disposed on the outer layer.

14. The method of claim 12, the joint strip further comprising:
an adhesive.

15. The method of claim 12, the joint strip disposed on a side portion of the outer surface.

16. The method of claim 12, the back surface further comprising:
an adhesive.

17. The method of claim 12, the flexible planar material and the granule layer together having flexibility suitable for rolling into a rolled configuration.

18. The method of claim 12, the first plurality of granules comprising a first color and the second plurality of granules comprising a second color, together forming a shingle pattern.

19. The method of claim 12, the first plurality of granules comprising a first pile height and the second plurality of granules comprising a second pile height, together forming a shingle pattern.

20. The method of claim 12, the granule layer comprising a continous layer of one or more granules in thickness.
